(19) United States
(12) Patent Application Publication
(10) Pub. No.: US 2003/0057821 A1
(43) Pub. Date: Mar. 27, 2003

(54) Nanoparticle phosphor

(75) Inventors: Richard Lee Fink, Austin, TX (US); Zvi Yaniv, Austin, TX (US)

Correspondence Address: Kelly K. Kordzik, Winstead Sechrest & Minick, 5400 Renaissance Tower, 1201 Elm Street, Dallas, TX, 75270, US

(73) Assignee: SI Diamond Technology, Inc.

(21) Appl. No.: 10/253,025

(22) Filed: Sep. 24, 2002

Related U.S. Application Data
(60) Provisional application No. 60/325,034, filed on Sep. 26, 2001.

(51) Int. Cl. H01J 29/10

(52) U.S. Cl. 313/461

(57) ABSTRACT

Differently sized silicon nanoparticles are used as a phosphor material for cathode ray tubes, field emission displays, or liquid crystal displays. The differently sized particles will emit different light wavelengths, such as red, green, and blue. Thus, the same material can be used for all three phosphors.

### CROSS REFERENCE TO RELATED APPLICATION

This Application claims priority to U.S. Provisional Patent Application Serial No. 60/325,034.

### TECHNICAL FIELD

The present invention relates in general to phosphors, and in particular, to phosphors used in display applications.

### BACKGROUND INFORMATION

Phosphors are used in many applications where the kinetic energy of electrons are converted to light energy. Phosphors can also be used in applications where one wants to convert light energy in high frequency bands (e.g., UV band) to light energy in low frequency bands (e.g., visible spectrum). Examples include many display applications. The cathode ray tube (CRT) is a display technology found in many television sets in homes world-wide. In the CRT, the image is formed by aiming an electron beam at a phosphor faceplate. The intensity of the electron beam is varied as a function of the position of the beam on the screen. Light is produced by the phosphor; the intensity of the light is roughly proportional to the intensity of the electron beam. The color of the light is dependant on the chemistry of the phosphor. Another example is the thin-CRT, commonly known as the Field Emission Display (FED). The function of the phosphor in the FED is similar to that in the CRT. There are also some Liquid Crystal Display (LCD) technologies that use phosphor to convert UV light energy.

There are many technical demands for phosphor material that impact the display product. The color that the phosphor emits is critical. Some applications want broad bands, other applications want very narrow bands of color (pure color). The central wavelength (central color) is also important. Most display applications require long lifetimes (10,000-50,000 hrs). The higher the efficiency of the phosphor (efficiency of energy conversion), the less power is required to operate the display device. The phosphor must not decompose with UV or e-beam illumination and must be vacuum compatible for many applications. Some phosphors may decompose and “poison” the cathode material used as the electron source (i.e., lead to decreased performance of the cathode). And, some applications want long decay rates to prevent “flicker” in the produced image; conversely, other applications desire short decay times for high speed applications.

Many phosphors are made up of a host crystal and a dopant material. For example, the P21 phosphor system is ZnS:Ag (blue), ZnS:Cu, Al (yellowish green) and Y₂O₂S:Eu (blue). In this case, the ZnS and Y₂O₂S systems are the host crystal and the Ag, Cu, Al and Eu are dopant atoms. Light is created in these phosphors by exciting the dopant atom with the energetic electron or the UV light. These excited impurities then decay, giving off a photon of characteristic energy (band of light). Typically, these phosphor materials are small particles that are on the size of microns. Until recently, the only way of modifying the phosphor material properties was to change the level of doping and make proper choices of dopant and host constituents.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates utilization of a phosphor in a CRT in accordance with an embodiment of the present invention;

FIG. 2 illustrates utilization of a phosphor in accordance with the present invention in an FED;

FIG. 3 illustrates utilization of a phosphor in an LCD in accordance with an embodiment of the present invention;

FIG. 4 illustrates utilization of a phosphor in a plasma display in accordance with an embodiment of the present invention; and

FIG. 5 illustrates a process for producing a phosphor in accordance with an embodiment of the present invention.

### DETAILED DESCRIPTION

In the following description, numerous specific details are set forth such as specific display structures to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted in as much as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

The present invention provides another parameter that can be changed to affect the properties of the phosphor material.

It is known that when the radius of a semiconductor crystallite is near the Bohr radius of the exciton, there is a quantum size effect and its electronic properties change (Y. Wnag and N. Herron, “Nanometer-Sized semiconductor Cluster: Material Synthesis, Quantum Size Effects and Photophysical Properties”, J. Phys. Chem. Vol. 95, P. 522, 1991). As the size of the semiconductor particle becomes smaller, the quasi-continuous energy bands that describe the valence and conduction band states of the material start to become more discrete. The valence and conduction levels develop sub-levels with small gaps between the sub-levels. Furthermore, the valence and conduction levels start to broaden in energy. The material is no longer characterized as a bulk solid but is closer to a molecule in terms of electronic behavior. Furthermore, the transition rules that govern the probability of transition of an electron between different states start to relax. A transition that was forbidden in a material as a bulk solid may become much more probable when the material becomes the size of a quantum dot. This is observed in the blue shift (shift to shorter wavelengths) in the optical bandgap for quantum sized ZnS particles in solution (H. Weller, U. Kock, M. Guitierrez and A. Henglein, “Photochemistry of Colloidal Metal Sulfides, Absorption and Fluorescence of Extremely Small ZnS Particles (The work of Neglected Dimensions)”, Ber. Bunsegnes Phys. Chem. Vol. 88, p. 649, 1984). Most of the II-VI and some III-V and group IV semiconductors have been prepared as quantum size effects in their physical properties. The size at which the particles demonstrate changes in their bandgap from the quantum size effects varies with the intrinsic electronic structure of the compound, but typically appear when below 100 Angstroms in diameter. To exhibit quantum size effects it is also necessary for the particles to remain isolated from one another; if allowed to aggregate, the material exhibits bulk properties despite the small size of the individual particles.

Gallagher, Bhargava, and Racz (U.S. Pat. No. 6,048,616) describe the results of fabricating ZnS:Mg nanocrystals (doped particles <100 Angstroms). The efficiency when grown at room temperature is higher than the same material grown in bulk (micron size particles or larger). The doped nanocrystals also emit light significantly faster (shorter luminescent decay time) than that observed with corresponding bulk material. Gallagher also teaches that these nanoparticles must be separated from each other in order to maintain their unique properties. If they coagulate, then they start to act like bulk material. In order to keep them separate, they coated the surface of the particles with a surface active agent often referred to as surfactants.

A recent article by Holmes et al. (“Highly Luminescent Silicon Nanocrystals with Discrete Optical Transitions”, Justin D. Holmes, Kirk J. Ziegler, R. Christopher Doty, Lindsay E. Pell, Keith P. Johnston, and Brian A. Korgel, J. Am. Chem. Soc., Vol. 123, pp. 3743-3748, Apr. 25, 2001) presented experimental data that shows that they have been able to grow nanosize particles of Si. They also demonstrated two important parameters concerning these nanoparticles of Si: the quantum efficiency is very high (23% at room temperature), and the luminescence spectra is size dependent (i.e., the luminescent color is size-tunable). Fifteen Angstrom particles emit in the blue, and 25-40 Angstrom particles emit in the green. The material of Holmes et al. was also coated with a hydrocarbon ligand much like the work of Gallagher et al. Additionally, 40-100 Angstrom particles maybe engineered to emit red light.

This material can be used as a phosphor material for CRT, FED, plasma and LCD displays. It has several advantages over other materials used as phosphors. The same material can be used for both red, green and blue phosphor. One then needs to manufacture or filter the material to a certain size that corresponds to the color desired.

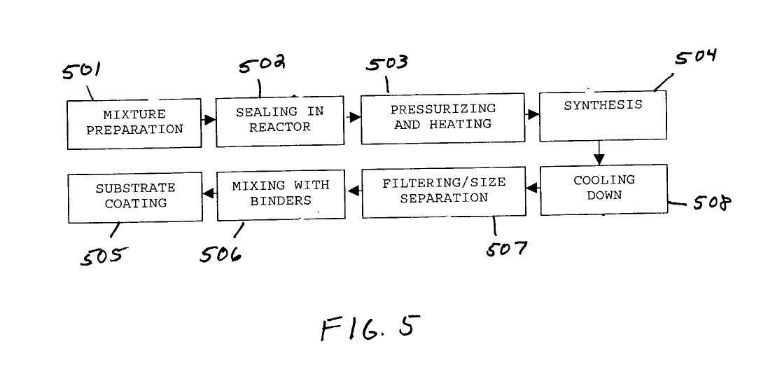

Referring to FIG. 5, Si nanoparticles can be obtained in the reaction of thermal decomposition of silicon precursors such as silanes, preferably diphenylsilane (DPS), at high pressure and high temperature. In step 501, a reaction mixture is prepared which contains DPS and an organic solvent, whereas the part of DPS in that mixture may vary from 0.1% to 100%, preferably from 5% to 50%. The organic solvent can be Hexane, Toluene, Octanol, or other liquid compound in which DPS is soluble. In step 502, the reaction mixture is placed into a reactor made of a metal or metal alloy and sealed. In step 503, the reactor with the mixture is heated to a high temperature, from 400C to 600C, preferably from 420C to 520C. At the same time, the pressure inside the reactor increases. There are at least two ways to increase the pressure in the reactor. The first way consists of external pressurizing the content of the reactor, by means of a tubing which, from the first end, is attached to a pressurizing device such as a high-pressure pump or press, and at the second end is attached to the reactor. The second way consists in using a bomb reactor approach in which the liquid mixture partly fills the reactor and a gas fills in the rest of the reactor. The gas should be chemically inert with respect to the reaction that takes place. This gas could be argon, helium, nitrogen, or similar gas, or solvent vapor. The pressure maintained in the reaction is above one atmosphere, and may range typically from 10 to 1000 bar, preferably from 50 to 500 bar. In step 504, the reaction should proceed for some period of time that may range from minutes to hours, preferably more than 5 minutes. After the decomposition of DPS, in step 505, the mixture is cooled down. It will contain silicon nanoparticles.

In step 506, silicon nanoparticles are then filtered out by size using a centrifuge and/or a nanoporous filter. Using filters with different pore sizes, nanoparticles can be obtained with necessary average sizes and size distributions. While the nanoparticle size specifies the luminescence color, the size distribution specifies the width of the luminescence band. The luminescence bandwidth is approximately two times larger than the width of the size distribution. This makes the filtering process very important in obtaining the narrow-band light emission necessary in CRT phosphors.

Referring to step 508, Si nanoparticles are then used to make a phosphor screen. In a first embodiment, silicon nanoparticles may be deposited on a transparent substrate using a spin-coat technique, spraying technique, settling technique, or other standard method of coating used in a phosphor screen manufacturing industry. In step 507, a binder can be added to a mixture with Si nanoparticles to ensure good adhesion of nanoparticles to the substrate and to each other. In a second embodiment, Si nanoparticles are mixed with a host dielectric powder material, which is deposited over a substrate. The powder material scatters the emitted light and visually intensifies the brightness of the Si nanoparticle luminescence.

High efficiency phosphor can be obtained, especially for low voltage operation (1000V-5000V electron acceleration). Since the particle is small, it will be easier for low voltage electrons to excite them since it is easier for these low energy electrons to excite the core of the particles. The luminescence of larger, standard phosphors, such as P22 phosphors, are dominated by surface effects of the particle when excited by low energy electrons. The surface properties can be very poor compared to the nanosize particles. Si will not decompose easily and is stable to high temperatures. This leads to a significant decrease in the possibility that the phosphor will “poison” the cathode material. Si is also highly vacuum compatible, leading to lower outgassing in a vacuum envelope such as a CRT or FED device. The fabrication of Si nanoparticles is more environmentally friendly compared to ZnS or similar materials.

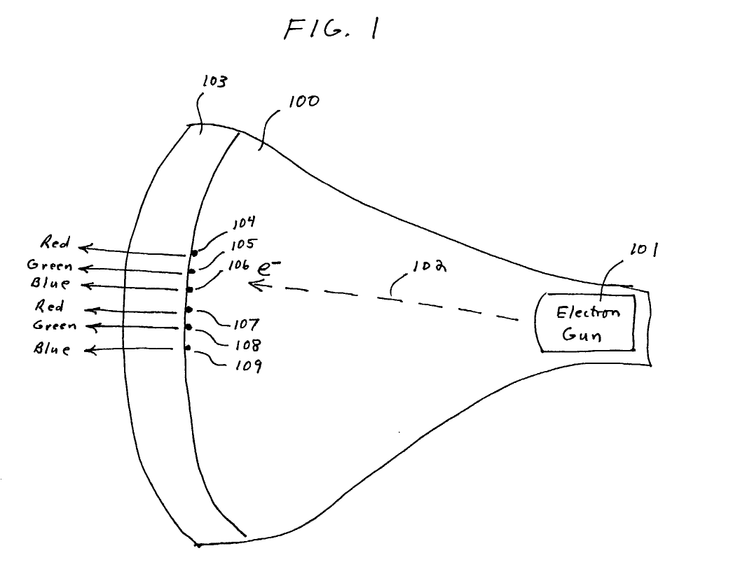

Referring to FIG. 1, there is illustrated a cathode ray tube (CRT) 100 manufactured in accordance with the present invention. Attached to the glass bulb 100 is a glass face plate 103 having a glass substrate with silicon nanoparticles 104109 deposited thereon. FIG. 1 only shows such a number of silicon nanoparticles for the sake of simplicity. Naturally, silicon nanoparticles will be deposited at each red, green, and blue subpixel location. Further, if other colors are desired, other sized silicon nanoparticles may be utilized. Furthermore, the present invention is not limited to silicon nanoparticles, but could be implemented with other nanoparticles able to emit different wavelengths of light. In this example, the red nanoparticles 104, 107 are of a first size, the green nanoparticles 105, 108 are of a second size, and the blue nanoparticles 106, 109 are of a third size. An electron gun 101 is placed so that it emits a scanned electron beam 102 towards the face plate 103 to bombard the silicon nanoparticles 104-109 at the respective subpixel locations. As the silicon nanoparticles of certain sizes are bombarded by the electron beam 102, they will then emit their corresponding wavelength of light.

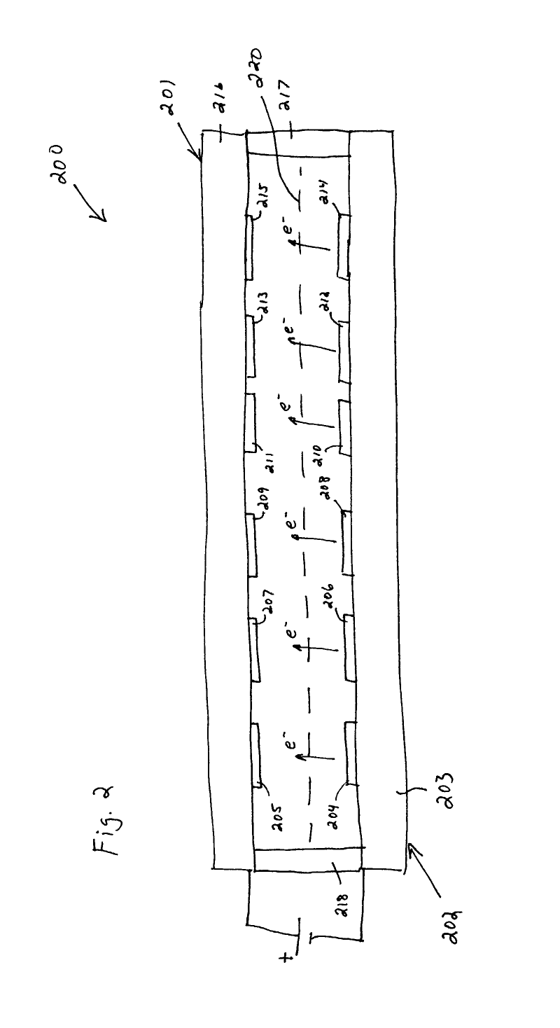

Referring to FIG. 2, there is illustrated an alternative embodiment of the present invention whereby a voltage source is utilized to create electric field to cause the emission of electrons from electron sources, such as cathodes 204, 206, 208, 210, 212, and 214, which have been deposited on cathode 202 having substrate 203. The cathodes can be hot cathode sources or cold cathode sources, such as micro-tip cathodes or flat cathodes such as carbon cold cathodes. These sources can be gated in a triode mode or ungated in a diode mode. Spacers 217, 218 are utilized to position an anode 201 a distance away from the cathode 202. The anode 201 comprises a glass substrate 216 having phosphor locations 205, 207, 209, 211, 213, and 215 deposited thereon. In this example, “red” size silicon nanoparticles are deposited at phosphor location 205; “blue” size silicon nanoparticles are deposited at phosphor location 207; and “green” size silicon nanoparticles are deposited at location 209. Locations 211, 213, and 215 are similarly implemented. As electrons from cathode 204 are emitted towards “red” size silicon nanoparticles 205, then red light will be emitted therefrom. The other sized phosphor nanoparticles will emit their respective colored light in a similar fashion.

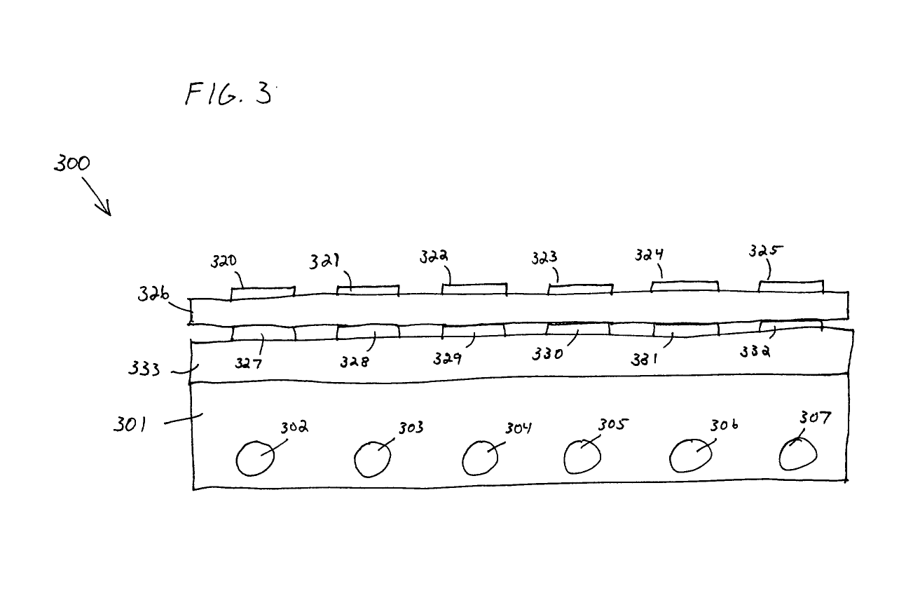

Referring to FIG. 3, there is illustrated yet another alternative embodiment of the present invention showing a display 300 whereby ultra-violet light sources 302-307 are utilized to bombard silicon nanoparticle phosphors 320-325 with ultra-violet light. An array 333 of liquid crystal light valves 327-332 may be implemented to open and close to regulate the passage of ultra-violet light from their respective sources 302-307 in a predetermined fashion. As ultra-violet light from a source bombards the phosphors 320-325, deposited on substrate 326, then light is emitted from those phosphors. Again, each of the phosphor locations 320-325 may be subpixel locations each having a certain sized group of silicon nanoparticle phosphors. For example, location 320 may contain silicon nanoparticles sized to emit light of a red wavelength when bombarded by ultra-violet light.

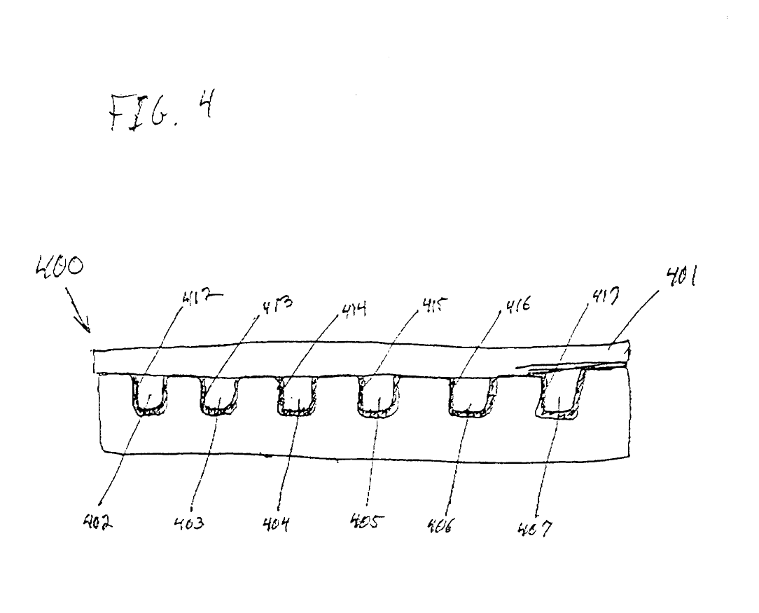

Referring to FIG. 4, there is illustrated yet another alternative embodiment of the present invention showing a display 400 whereby a plasma is created in cells 402-407. The plasma is created by exciting a gas that is in each of the cells using high potentials that are applied to electrodes in the cell (not shown). The fabrication of plasma display panels (PDPs) is well known, and as such certain details are left out of the drawing to better illustrate the invention. The plasma generated in each of the cells creates ultra-violet light. As ultra-violet light created in each of the cells bombards the phosphors that coat the sides of the cells (412-417), then light is emitted from those phosphors. Again, each cell location may have subpixel locations each having a phosphor of silicon nanoparticles that are from a certain sized group. For example, cell 402 may contain a phosphor 412 that contains silicon nanoparticles sized to emit light of a red wavelength when bombarded by ultra-violet light from the plasma. One of the walls of the cells is a transparent glass sheet 401 that allows the light to leave the cell to be visible to a viewer.

Although the present invention and its advantages have been described in detail, it should be understood that various changes, substitutions and alterations can be made herein without departing from the spirit and scope of the invention as defined by the appended claims.

1. An apparatus comprising:
a substrate;
a first nanoparticle having a first size deposited on the substrate;
a second nanoparticle having a second size deposited on the substrate, wherein the first and second sizes are different; and
an energy beam source position relative to the substrate so that the energy beam bombards the first and second nanoparticles,
wherein the first size of the first nanoparticle is configured so that the first nanoparticle emits light of a first color when bombarded by the energy beam, and wherein the second size of the second nanoparticle is configured so that the second nanoparticle emits light of a second color when bombarded by the energy beam, wherein the first and second colors have different wavelengths.

2. The apparatus as recited in claim 1, wherein the first and second nanoparticles are both comprised of silicon.

3. The apparatus as recited in claim 1, wherein the energy beam is an electron beam.

4. The apparatus as recited in claim 1, wherein the energy beam is ultra-violet light.

5. A method of making a display screen comprising the steps of:
producing silicon nanoparticles of first and second sizes;
separating the silicon nanoparticles according to the first and second sizes; and
depositing the separated silicon nanoparticles onto a substrate.

6. The method as recited in claim 5, further comprising the step of:
positioning the substrate with the deposited silicon nanoparticles a predetermined distance from an energy beam source.

7. A display device comprising:
a substrate;
first silicon nanoparticles of a first size deposited on the substrate in a first pattern;
second silicon nanoparticles of a second size deposited on the substrate in a second pattern; and
an energy source positioned a distance from the substrate, wherein the first and second sizes are sufficiently different so that the first silicon nanoparticles emit light of a first wavelength when bombarded by energy from the energy source, and the second silicon nanoparticles emit light of a second wavelength when bombarded by energy from the energy source.

8. The display device as recited in claim 7, wherein the energy is an electron beam.

9. The display device as recited in claim 8, wherein the display device is a cathode ray tube.

10. The display device as recited in claim 8, wherein the display device is a field emission display.

11. The display device as recited in claim 7, wherein the energy is ultra-violet light.
